(19) United States
(12) Patent Application Publication
(10) Pub. No.: US 2026/0016617 A1
(43) Pub. Date: Jan. 15, 2026

(54) IMAGING LENS ASSEMBLY AND ELECTRONIC DEVICE

(71) Applicant: LARGAN PRECISION CO., LTD., Taichung City (TW)

(72) Inventors: Chi-Wei CHI, Taichung City (TW); Wei-Fong HONG, Taichung City (TW); Chen-Wei FAN, Taichung City (TW); Syuan Ruei LAI, Taichung City (TW); Chien-Pang CHANG, Taichung City (TW)

(21) Appl. No.: 19/265,039

(22) Filed: Jul. 10, 2025

Related U.S. Application Data
(60) Provisional application No. 63/670,197, filed on Jul. 12, 2024.

(51) Int. Cl. G02B 1/118; G02B 1/115; G02B 13/00

(52) U.S. Cl. CPC G02B 1/118; G02B 1/115; G02B 13/0045

(57) ABSTRACT

An imaging lens assembly having an optical axis includes a lens element assembly including a plurality of lens elements. The lens elements are disposed along the optical axis, and include a first lens element and an anti-reflection coating. The first lens element includes a first object-side surface and a first image-side surface, wherein the optical axis passes through the first object-side surface, and the first image-side surface is disposed relative to the first object-side surface along the optical axis. The anti-reflection coating is disposed on at least one surface of the first object-side surface and the first image-side surface. The anti-reflection coating includes a nano structure layer and an intermediate layer. A main material of the nano structure layer is Aluminium Oxide, and the nano structure layer includes a plurality of ridge-like protrusions extending non-directionally, each of the ridge-like protrusions tapers and extends from a bottom to a top.

### RELATED APPLICATIONS

This application claims priority to Provisional Application Ser. No. 63/670,197, filed Jul. 12, 2024, which is herein incorporated by reference.

### BACKGROUND

### Technical Field

The present disclosure relates to an imaging lens assembly. More particularly, the present disclosure relates to an imaging lens assembly applicable to portable electronic devices.

### Description of Related Art

In recent years, portable electronic devices have developed rapidly. For example, intelligent electronic devices and tablets have been filled in the lives of modern people, and imaging lens assemblies mounted on portable electronic devices have also prospered. However, as technology advances, the quality requirements of the imaging lens assembly are becoming higher and higher. Therefore, an imaging lens assembly, which can enhance the image quality, needs to be developed.

### SUMMARY

According to one aspect of the present disclosure, an imaging lens assembly, which has an optical axis, includes a lens element assembly including a plurality of lens elements. The lens elements are disposed along the optical axis, and include a first lens element, a second lens element and at least two anti-reflection coatings. The first lens element includes a first object-side surface and a first image-side surface. The optical axis passes through the first object-side surface. The first image-side surface is disposed relative to the first object-side surface along the optical axis. The second lens element includes a second object-side surface and a second image-side surface. The optical axis passes through the second object-side surface. The second image-side surface is disposed relative to the second object-side surface along the optical axis. The anti-reflection coatings are disposed on at least one surface of the first object-side surface and the first image-side surface and at least one surface of the second object-side surface and the second image-side surface. Each of the anti-reflection coatings includes a nano structure layer and an intermediate layer. A main material of the nano structure layer is Aluminium Oxide, wherein the nano structure layer includes a plurality of ridge-like protrusions extending non-directionally, each of the ridge-like protrusions tapers and extends from a bottom to a top, and a structure average height of the ridge-like protrusions is greater than 26 nm and smaller than 356 nm. The intermediate layer is disposed between the nano structure layer and the at least one surface. A wavelength from 400 nm to 680 nm relative to a reflectance of each of the at least two anti-reflection coatings can be separated to two wavelength bands, which are, from short to long, a first wavelength band and a second wavelength band. The first wavelength band is from 400 nm to 470 nm, a minimum reflectance relative to the first wavelength band is a first reference value, and the first reference value is RV1, the second wavelength band is from 480 nm to 580 nm, a maximum reflectance relative to the second wavelength band is a second reference value, and the second reference value is RV2, the following conditions are satisfied: 0%<RV1<0.1%; and 0.1%<RV2<1%.

According to one aspect of the present disclosure, an imaging lens assembly, which has an optical axis, and includes a lens element assembly including a plurality of lens elements. The lens elements are disposed along the optical axis, and include a first lens element and at least one anti-reflection coating. The first lens element includes a first object-side surface and a first image-side surface. The optical axis passes through the first object-side surface. The first image-side surface is disposed relative to the first object-side surface along the optical axis. The at least one anti-reflection coating is disposed on at least one surface of the first object-side surface and the first image-side surface, and includes a nano structure layer and an intermediate layer. A main material of the nano structure layer is Aluminium Oxide, wherein the nano structure layer includes a plurality of ridge-like protrusions extending non-directionally, each of the ridge-like protrusions tapers and extends from a bottom to a top, and a structure average height of the ridge-like protrusions is greater than 26 nm and smaller than 356 nm. An intermediate layer is disposed between the nano structure layer and the at least one surface. When a paraxial distance between the first object-side surface and the first image-side surface is D, the following condition is satisfied: 0.1 mm<D≤0.42 mm. A wavelength from 400 nm to 680 nm relative to a reflectance of the at least one anti-reflection coating can be separated to two wavelength bands, which are, from short to long, a first wavelength band and a second wavelength band, wherein the first wavelength band is from 400 nm to 470 nm, a minimum reflectance relative to the first wavelength band is a first reference value, the first reference value is RV1, the second wavelength band is from 480 nm to 580 nm, a maximum reflectance relative to the second wavelength band is a second reference value, the second reference value is RV2, the following conditions are satisfied: 0%<RV1<0.1%; and 0.5%<RV2<1%.

According to one aspect of the present disclosure, an electronic device includes the aforementioned imaging lens assembly of any one of the aforementioned aspect.

### BRIEF DESCRIPTION OF THE DRAWINGS

FIG. 1A is a schematic view of an imaging lens assembly according to the 1st Embodiment of the present disclosure.

FIG. 1B is a schematic view of the first lens element according to the 1st Embodiment in FIG. 1A.

FIG. 1C is a schematic view of the second lens element according to the 1st Embodiment in FIG. 1A.

FIG. 2A is a schematic view of an imaging lens assembly according to the 2nd Embodiment of the present disclosure.

FIG. 2B is a schematic view of the first lens element according to the 2nd Embodiment in FIG. 2A.

FIG. 3A is a schematic view of Reflectance (%)-Wavelength (nm) of the anti-reflection coatings which are coated on the tested lens elements of the 1st example, the 2nd example, the 3rd example and the 4th example.

FIG. 3B is a schematic view of Reflectance (%)-Wavelength (nm) of the anti-reflection coatings which are coated on the tested lens elements of the 5th example, the 6th example, the 7th example and the 8th example.

FIG. 3C is a schematic view of Reflectance (%)-Wavelength (nm) of the anti-reflection coatings which are coated on the tested lens elements of the 9th example, the 10th example, the 11th example and the 12th example.

FIG. 3D is a schematic view of Reflectance (%)-Wavelength (nm) of the anti-reflection coatings which are coated on the tested lens elements of the 13th example, the 14th example, the 15th example and the 16th example.

FIG. 3E is a schematic view of Reflectance (%)-Wavelength (nm) of the anti-reflection coatings which are coated on the tested lens elements of the 17th example, the 18th example, the 19th example and the 20th example.

FIG. 4A is a schematic view of an electronic device according to the 3rd Embodiment of the present disclosure.

FIG. 4B is another schematic view of the electronic device according to the 3rd Embodiment of FIG. 4A.

FIG. 4C is a schematic view of an image captured via the electronic device according to the 3rd embodiment of FIG. 4A.

FIG. 4D is another schematic view of the image captured via the electronic device according to the 3rd embodiment of FIG. 4A.

FIG. 4E is the other schematic view of the image captured via the electronic device according to the 3rd embodiment of FIG. 4A.

FIG. 5 is a schematic view of an electronic device according to the 4th embodiment of the present disclosure.

### DETAILED DESCRIPTION

The present disclosure provides an imaging lens assembly, which has an optical axis, and includes a lens element assembly including a plurality of lens elements. The lens elements are disposed along the optical axis, and include a first lens element, a second lens element and at least two anti-reflection coatings. The first lens element includes a first object-side surface and a first image-side surface. The optical axis passes through the first object-side surface. The first image-side surface is disposed relative to the first object-side surface along the optical axis. The second lens element includes a second object-side surface and a second image-side surface. The optical axis passes through the second object-side surface. The second image-side surface is disposed relative to the second object-side surface along the optical axis. The anti-reflection coatings are disposed on at least one surface of the first object-side surface and the first image-side surface and at least one surface of the second object-side surface and the second image-side surface. Each of the anti-reflection coatings includes a nano structure layer and an intermediate layer. A main material of the nano structure layer is Aluminium Oxide, wherein the nano structure layer includes a plurality of ridge-like protrusions extending non-directionally, each of the ridge-like protrusions tapers and extends from a bottom to a top, and a structure average height of the ridge-like protrusions is greater than 26 nm and smaller than 356 nm. The intermediate layer is disposed between the nano structure layer and the at least one surface. A wavelength from 400 nm to 680 nm relative to a reflectance of each of the at least two anti-reflection coatings can be separated to two wavelength bands, which are, from short to long, a first wavelength band and a second wavelength band. The first wavelength band is from 400 nm to 470 nm, a minimum reflectance relative to the first wavelength band is a first reference value, and the first reference value is RV1, the second wavelength band is from 480 nm to 580 nm, a maximum reflectance relative to the second wavelength band is a second reference value, and the second reference value is RV2, the following conditions are satisfied: 0%<RV1<0.1%; and 0.1%<RV2<1%. Therefore, it is favorable for providing better low reflectance performance via the gradient refractive index relative to different wavelengths and different incident angles of light formed by the ridge-like protrusions of the anti-reflection coating. Further, it is favorable for improving the light glare by arranging at least two lens elements in the imaging lens assembly with the anti-reflection coating. Moreover, when the reflectance of the anti-reflection coatings satisfies the aforementioned conditions, the light glare also can be improved. Furthermore, it is favorable for increasing the manufacturing efficiency by arranging the nano structure layer with lower structure average height.

Specifically, a main material of intermediate layer can include SiO₂, which is favorable for enhancing the connecting stability of the nano structure layer, wherein the main material refers to the ingredient with the highest weight percentage. Since the lens element with the conventional anti-reflection coating tends to produce the stray light with excessive glare near light sources, thus, the reflectance of the anti-reflection coatings can be adjusted by adjusting parameters, such as the structure average height of the nano structure layer or the composition and thickness of the intermediate layer. It should be mentioned that a number of the lens elements with anti-reflection coatings and the arrangement thereof is according to the experiment and requirement, and will not be limited to the present disclosure. Moreover, the surface of the nano structure layer can have a plurality of holes, thus the variation of the equivalent refractive index of the nano structure layer can be more linear.

When an average reflectance relative to the second wavelength band is RA2, the following condition is satisfied: 0.5%<RA2<0.9%. Therefore, it is favorable for improving the stray light with excessive glare near light sources via the second wavelength band with higher reflectance.

When the second reference value is RV2, the following condition is satisfied: 0.5%<RV2<1%. Therefore, it is favorable for further reducing the glare light near light sources by arranging B-type anti-reflection coating. It should be noted that in the present disclosure, the anti-reflection coating satisfying the conditions 0%<RV1<0.1%, 0.1%<RV2<1%, 0.5%<RA2<0.9% and 0.5%<RV2<1% is defined as B-type anti-reflection coating.

When the average reflectance relative to the second wavelength band is RA2, the following condition is satisfied: 0.1%<RA2<0.35%. Therefore, it is favorable for increasing the transmittance of the imaging lens assembly via the second wavelength band with lower reflectance.

When the second reference value is RV2, the following condition is satisfied: 0.15%<RV2<0.5%. Therefore, it is favorable for decreasing the surface reflection of the lens element.

The wavelength from 400 nm to 680 nm relative to the reflectance of each of the at least two anti-reflection coatings can be further separated to a third wavelength band, the third wavelength band is from 600 nm to 680 nm, a minimum reflectance relative to the third wavelength band is a third reference value, the third reference value is RV3, the following condition is satisfied: 0%<RV3<0.1%. Therefore, it is favorable for reducing the stray light of red light wavelength band by further adjusting the reflectance of the third wavelength band.

When an average reflectance relative to the first wavelength band is RA1, the following condition is satisfied: 0%<RA1<0.2%. Therefore, it is favorable for increasing the transmittance of blue light wavelength band.

When an average reflectance relative to the third wavelength band is RA3, the following condition is satisfied: 0%<RA3<0.1%. Therefore, it is favorable for increasing the transmittance of red light wavelength band by arranging A-type anti-reflection coating. It should be noted that in the present disclosure, the anti-reflection coating satisfying the conditions 0%<RV1<0.1%, 0.1%<RV2<1%, 0.1%<RA2<0.35%, 0.15%<RV2<0.5%, 0%<RV3<0.1%, 0%<RA1<0.2% and 0%<RA3<0.1% is defined as A-type anti-reflection coating.

When a paraxial distance between the first object-side surface and the first image-side surface is D, the following condition is satisfied: 0.1 mm<D≤0.42 mm. Therefore, it is favorable for obtaining better improvement effect of light glare of the imaging lens assembly.

The imaging lens assembly can further include a third lens element, which includes a third object-side surface and a third image-side surface. The optical axis passes through the third object-side surface. The third image-side surface is disposed relative to the third object-side surface along the optical axis. A number of the at least two anti-reflection coatings is at least three, one of the at least three anti-reflection coatings is disposed on at least one surface of the third object-side surface and the third image-side surface of the third lens element. The wavelength from 400 nm to 680 nm relative to a reflectance of the anti-reflection coating disposed on the third lens element can be further separated to a third wavelength band, the third wavelength band is from 600 nm to 680 nm, a minimum reflectance relative to the third wavelength band is a third reference value, the third reference value is RV3, the following condition is satisfied: 0%<RV3<0.1%. Therefore, it is favorable for increasing the transmittance of the imaging lens assembly by compensating the first lens element and the second lens element with B-type anti-reflection coatings via the third lens element with A-type anti-reflection coating which has lower reflectance relative to the third wavelength band. That is, it can be deemed as the arrangement mixed with A-type anti-reflection coating and B-type anti-reflection coating.

When an average reflectance of each of the at least two anti-reflection coatings relative to the wavelength from 400 nm to 680 nm is Ravg, the following condition is satisfied: 0%<Ravg<0.6%. Therefore, it is favorable for providing the lens element with better transmittance.

When the first reference value is RV1, and the second reference value is RV2, the following condition is satisfied: 5<RV2/RV1<70. Therefore, it is favorable for maintaining low reflectance and also improving the stray light with light glare.

A number of the lens elements of the lens element assembly can be at least seven. Since the imaging lens assembly with multiple lens elements is favorable for enhancing imaging performance but is easily to generate light glare, therefore, in the present disclosure, the arrangement of the anti-reflection coatings is favorable for improving the stray light with glare of the imaging lens assembly with multiple lens elements.

A top of the intermediate layer can be partially contacted with air. In other words, the top of the intermediate layer can be partially covered by the nano structure layer. Therefore, it is favorable for adjusting the gradient refractive index of the anti-reflection coatings. It should be noted that according to the present disclosure, the intermediate layer can be multiple-film layers. The thin film interference can be formed by alternatively stacking the film layers with high and low refractive indices so as to further adjust the first reference value to the third reference value.

The structure average height of the ridge-like protrusions can be greater than 41 nm and smaller than 236 nm. Therefore, it is favorable for enhancing the manufacturing efficiency of the anti-reflection coatings.

In the lens element assembly, a number of the lens elements with at least two anti-reflection coatings accounts for at least 40% of a total number of the lens elements. Therefore, it is favorable for improving the light glare of the imaging lens assembly.

The present disclosure provides an imaging lens assembly, which has an optical axis, and includes a lens element assembly including a plurality of lens elements. The lens elements are disposed along the optical axis, and include a first lens element and at least one anti-reflection coating. The first lens element includes a first object-side surface and a first image-side surface. The optical axis passes through the first object-side surface. The first image-side surface is disposed relative to the first object-side surface along the optical axis. The at least one anti-reflection coating is disposed on at least one surface of the first object-side surface and the first image-side surface, and includes a nano structure layer and an intermediate layer. A main material of the nano structure layer is Aluminium Oxide, wherein the nano structure layer includes a plurality of ridge-like protrusions extending non-directionally, each of the ridge-like protrusions tapers and extends from a bottom to a top, and a structure average height of the ridge-like protrusions is greater than 26 nm and smaller than 356 nm. An intermediate layer is disposed between the nano structure layer and the at least one surface. When a paraxial distance between the first object-side surface and the first image-side surface is D, the following condition is satisfied: 0.1 mm<D≤0.42 mm. A wavelength from 400 nm to 680 nm relative to a reflectance of the at least one anti-reflection coating can be separated to two wavelength bands, which are, from short to long, a first wavelength band and a second wavelength band, wherein the first wavelength band is from 400 nm to 470 nm, a minimum reflectance relative to the first wavelength band is a first reference value, the first reference value is RV1, the second wavelength band is from 480 nm to 580 nm, a maximum reflectance relative to the second wavelength band is a second reference value, the second reference value is RV2, the following conditions are satisfied: 0%<RV1<0.1%; and 0.5%<RV2<1%. Therefore, it is favorable for providing better low reflectance performance via the gradient refractive index relative to different wavelengths and different incident angles of light formed by the ridge-like protrusions of the anti-reflection coating. Further, when the reflectance of the anti-reflection coatings satisfies the aforementioned conditions, the light glare also can be improved. Furthermore, it is favorable for obtaining better improvement effect of light glare of the imaging lens assembly.

When the paraxial distance between the first object-side surface and the first image-side surface is D, the following condition is satisfied: 0.15 mm<D≤ 0.375 mm.

When an average reflectance relative to the second wavelength band is RA2, the following condition is satisfied: 0.5%<RA2<0.9%. Therefore, it is favorable for improving the stray light with excessive glare near light sources via the second wavelength band with higher reflectance.

When an average reflectance relative to the first wavelength band is RA1, the following condition is satisfied: 0%<RA1<0.2%. Therefore, it is favorable for increasing the transmittance of blue light wavelength band.

When an average reflectance of each of the at least one anti-reflection coating relative to the wavelength from 400 nm to 680 nm is Ravg, the following condition is satisfied: 0%<Ravg<0.6%. Therefore, it is favorable for providing the lens element with better transmittance.

When the first reference value is RV1, and the second reference value is RV2, the following condition is satisfied: 5<RV2/RV1<70. Therefore, it is favorable for maintaining low reflectance and also improving the stray light with light glare.

A number of the lens elements of the lens element assembly can be at least seven. Since the imaging lens assembly with multiple lens elements is favorable for enhancing imaging performance but is easily to generate light glare, therefore, in the present disclosure, the arrangement of the anti-reflection coatings is favorable for improving the stray light with glare of the imaging lens assembly with multiple lens elements.

A top of the intermediate layer can be partially contacted with air. Therefore, it is favorable for adjusting the gradient refractive index of the anti-reflection coatings.

The structure average height of the ridge-like protrusions is greater than 41 nm and smaller than 236 nm. Therefore, it is favorable for enhancing the manufacturing efficiency of the anti-reflection coatings.

The present disclosure an electronic device, which includes any one of the aforementioned imaging lens assembly.

### 1st Embodiment

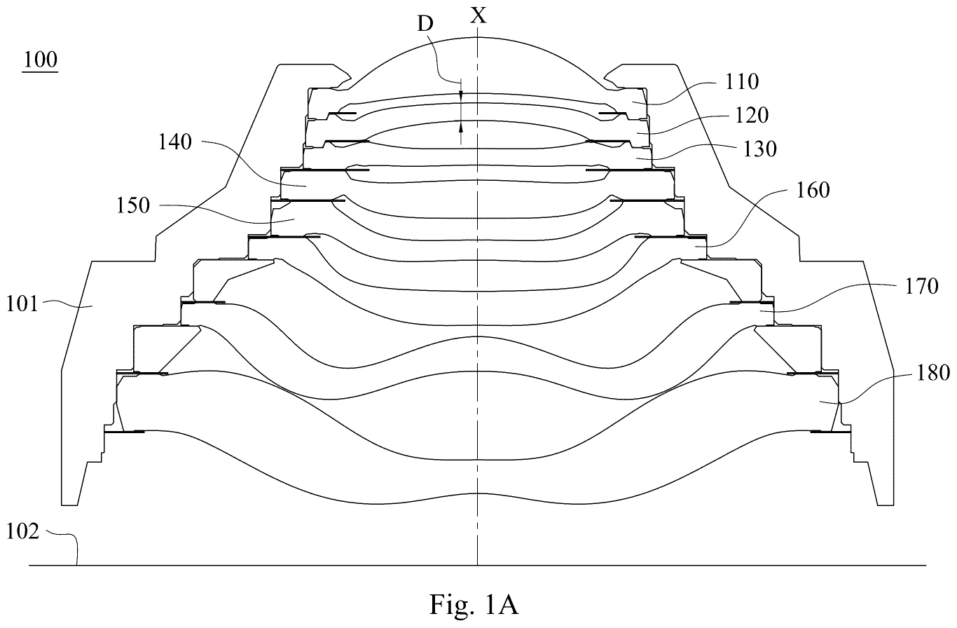

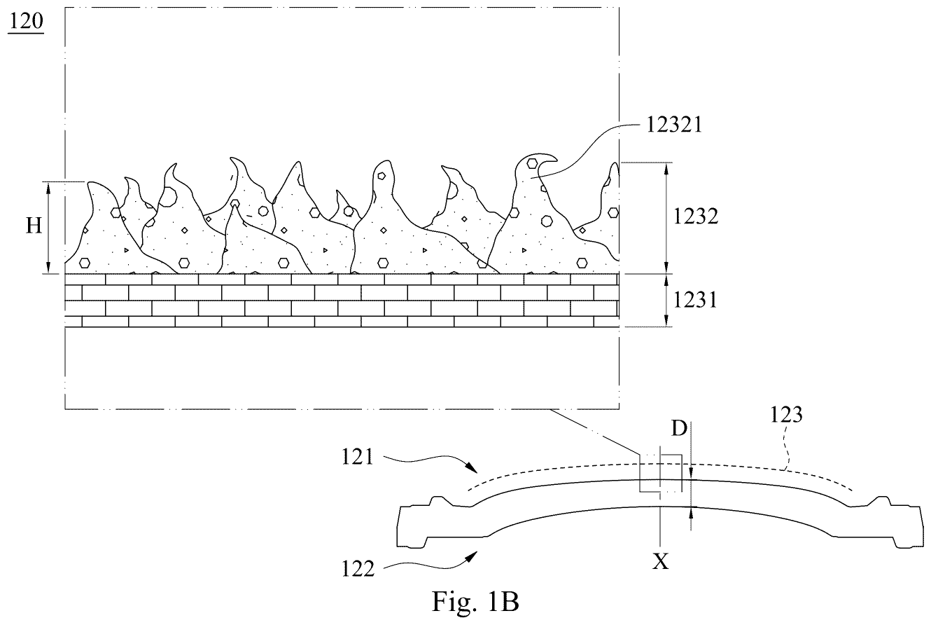

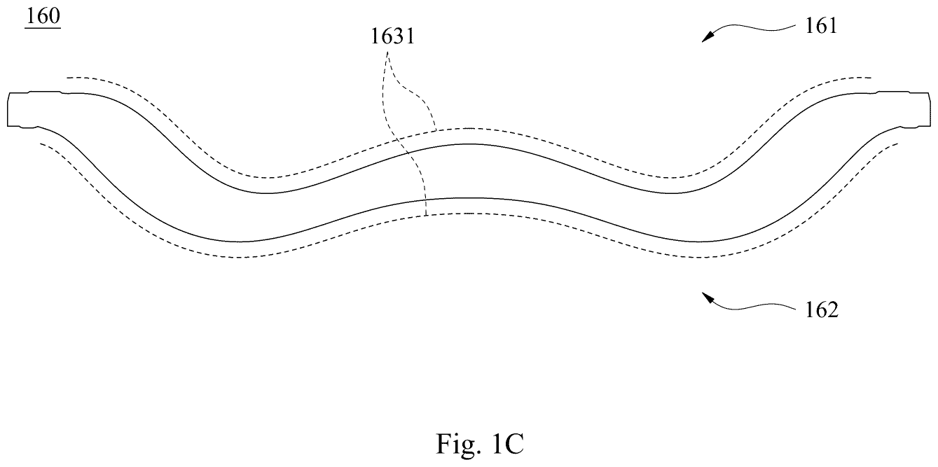

FIG. 1A is a schematic view of an imaging lens assembly 100 according to the 1st Embodiment of the present disclosure. In FIG. 1A, the imaging lens assembly 100 has an optical axis X, and includes a lens element assembly (its reference numeral is omitted), a lens barrel 101 and an image surface 102. The lens element assembly is disposed in the lens barrel 101 along the optical axis X, and the image surface 102 is disposed an image side of the lens barrel 101 and an image side of the lens element assembly along the optical axis X. The lens element assembly includes eight lens elements and a plurality of anti-reflection coatings (at least labelled in FIG. 1B and FIG. 1C). The eight lens elements are, from an object side to the image side, a lens element 110, a first lens element 120, a lens element 130, two third lens elements 140, 150, a second lens element 160, a lens element 170 and a lens element 180, wherein the first lens element 120, the third lens elements 140, 150 and the second lens element 160 are disposed with the anti-reflection coating of the present disclosure, and the lens elements 110, 130, 170, 180 are disposed without the anti-reflection coating. The first lens element 120, the third lens elements 140, 150 and the second lens element 160 with the anti-reflection coatings will be described in detail in the following disclosure.

FIG. 1B is a schematic view of the first lens element 120 according to the 1st Embodiment in FIG. 1A. In FIG. 1B, the first lens element 120 includes a first object-side surface 121 and a first image-side surface 122, wherein the optical axis X passes through the first object-side surface 121, the first image-side surface 122 is disposed relative to the first object-side surface 121 along the optical axis X. The anti-reflection coating 123 is disposed on the first object-side surface 121 of the first lens element 120, and includes a nano structure layer 1232 and an intermediate layer 1231, wherein the intermediate layer 1231 is disposed between the nano structure layer 1232 and the first object-side surface 121. A main material of the nano structure layer 1232 is Aluminium Oxide, and the nano structure layer 1232 includes a plurality of ridge-like protrusions 12321 extending non-directionally, each of the ridge-like protrusions 12321 tapers and extends from a bottom to a top, and a structure average height of the ridge-like protrusions 12321 is greater than 26 nm and smaller than 356 nm. Specifically, the height of each ridge-like protrusion 12321 can be defined as, observed from the cross-sectional view (which is destructive measurement), a vertical height H from an absolute bottom of each ridge-like protrusion 12321 (which is the foot thereof) to the top of each ridge-like protrusion 12321 (which is the peak thereof). The height of each ridge-like protrusion 12321 might be different, so that an average structure height can be measured by at least three or more ridge-like protrusions 12321, and the ridge-like protrusions 12321 with identifiable outlines can be taken first.

Further, a paraxial distance (which is the distance near the optical axis X) between the first object-side surface 121 and the first image-side surface 122 is D, and D=0.353 mm.

FIG. 1C is a schematic view of the second lens element 160 according to the 1st Embodiment in FIG. 1A. In FIG. 1C, the second lens element 160 includes a second object-side surface 161 and a second image-side surface 162, wherein the optical axis X passes through the second object-side surface 161, the second image-side surface 162 is disposed relative to the second object-side surface 161 along the optical axis X. Two anti-reflection coatings 1631 are disposed on the second object-side surface 161 and the second image-side surface 162 of the second lens element 160, respectively. It should be mentioned that the structure and material of each anti-reflection coatings 1631 can be the same or similar to the anti-reflection coating 123 of the first lens element 120, and will not be described again herein.

Further, each of the third lens elements 140, 150 can include a third object-side surface (its reference numeral is omitted) and a third image-side surface (its reference numeral is omitted), wherein the optical axis X passes through the third object-side surface, the third image-side surface is disposed relative to the third object-side surface along the optical axis X. Both of the third object-side surface and the third image-side surface of each of the third lens elements 140, 150 have the anti-reflection coatings, which can be the same or similar to the anti-reflection coating 123 of the first lens element 120 or the anti-reflection coatings 1631 of the second lens element 160, and will not be described again herein.

### 2nd Embodiment

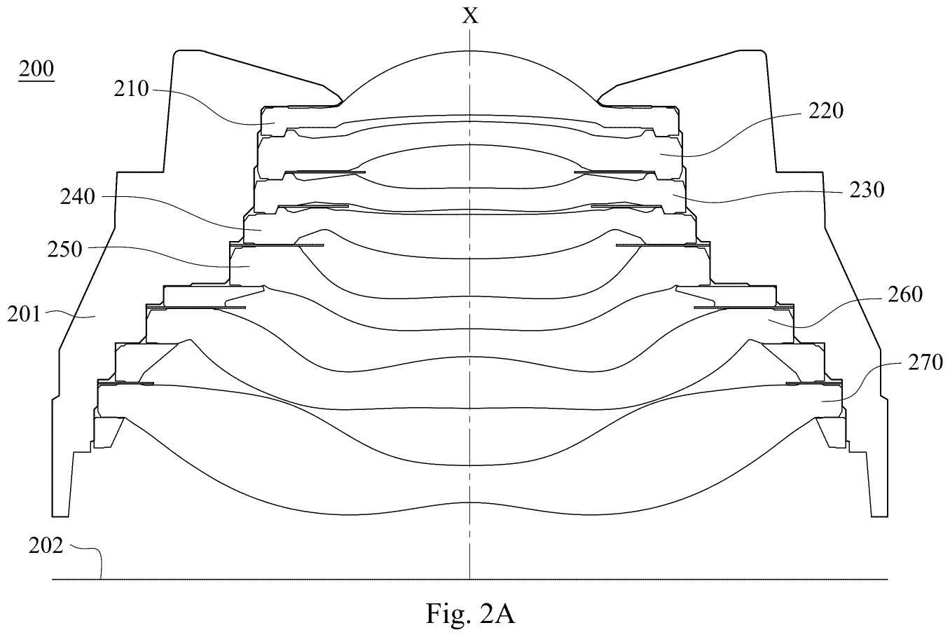

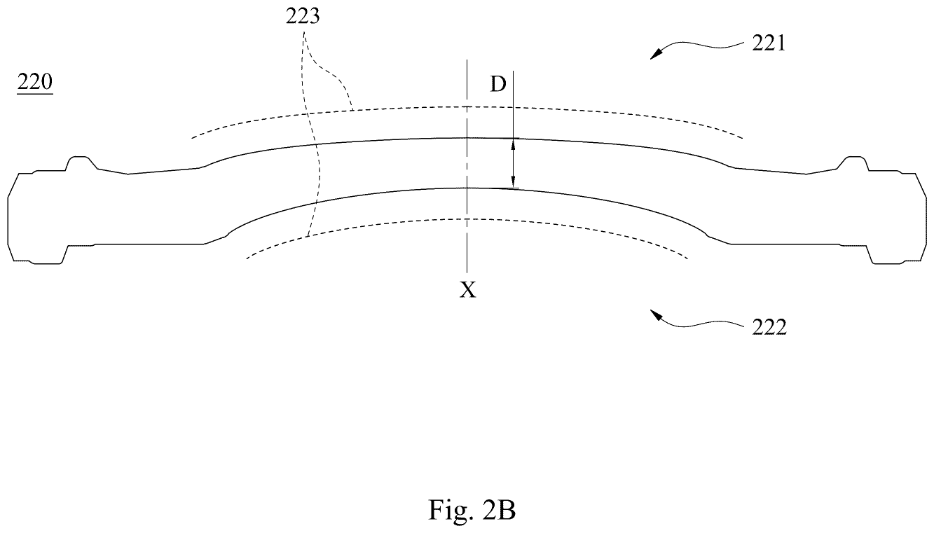

FIG. 2A is a schematic view of an imaging lens assembly 200 according to the 2nd Embodiment of the present disclosure. In FIG. 2A, the imaging lens assembly 200 has an optical axis X, and includes a lens element assembly (its reference numeral is omitted), a lens barrel 201 and an image surface 202. The lens element assembly is disposed in the lens barrel 201 along the optical axis X, and the image surface 202 is disposed an image side of the lens barrel 201 and an image side of the lens element assembly along the optical axis X. The lens element assembly includes seven lens elements and a plurality of anti-reflection coatings (at least labelled in FIG. 2B). The seven lens elements are, from an object side to the image side, a third lens element 210, a first lens element 220, a second lens element 230, two third lens elements 240, 250, a lens element 260 and a lens element 270, wherein the first lens element 220, the second lens element 230 and the third lens elements 210, 240, 250 are disposed with the anti-reflection coating of the present disclosure, and the lens elements 260, 270 are disposed without the anti-reflection coating. The first lens element 220, the second lens element 230 and the third lens elements 210, 240, 250 with the anti-reflection coatings will be described in detail in the following disclosure.

FIG. 2B is a schematic view of the first lens element 220 according to the 2nd Embodiment in FIG. 2A. In FIG. 2B, the first lens element 220 includes a first object-side surface 221 and a first image-side surface 222, wherein the optical axis X passes through the first object-side surface 221, the first image-side surface 222 is disposed relative to the first object-side surface 221 along the optical axis X. The anti-reflection coatings 223 are disposed on the first object-side surface 221 and the first image-side surface 222 of the first lens element 220, respectively. Each of the anti-reflection coatings 223 includes a nano structure layer (not shown in the drawings) and an intermediate layer (not shown in the drawings), wherein the intermediate layer is disposed between the nano structure layer and the first object-side surface 221 or the first image-side surface 222. A main material of the nano structure layer is Aluminium Oxide, and the nano structure layer includes a plurality of ridge-like protrusions (not shown in the drawings) extending non-directionally, each of the ridge-like protrusions tapers and extends from a bottom to a top, and a structure average height of the ridge-like protrusions is greater than 26 nm and smaller than 356 nm. In the 2nd Embodiment, the details of the nano structure layer, the intermediate layer and the ridge-like protrusions can be referred to the description and the drawings in the 1st Embodiment, and will not be described again herein.

Further, a paraxial distance (which is the distance near the optical axis X) between the first object-side surface 221 and the first image-side surface 222 is D, and D=0.333 mm.

Further, each of the second object-side surface (its reference numeral is omitted) and the second image-side surface (its reference numeral is omitted) of the second lens element 230 can be disposed with the anti-reflection coating (not shown in the drawings), each of the third object-side surface (its reference numeral is omitted) and the third image-side surface (its reference numeral is omitted) of each of the third lens element 240, 250 can be disposed with the anti-reflection coating (not shown in the drawings), and the third image-side surface (its reference numeral is omitted) of the third lens element 210 can be disposed with the anti-reflection coating (not shown in the drawings), wherein the anti-reflection coatings can be the same or similar to the anti-reflection coating 223 of the first lens element 220, and will not be described again herein.

### EXAMPLE

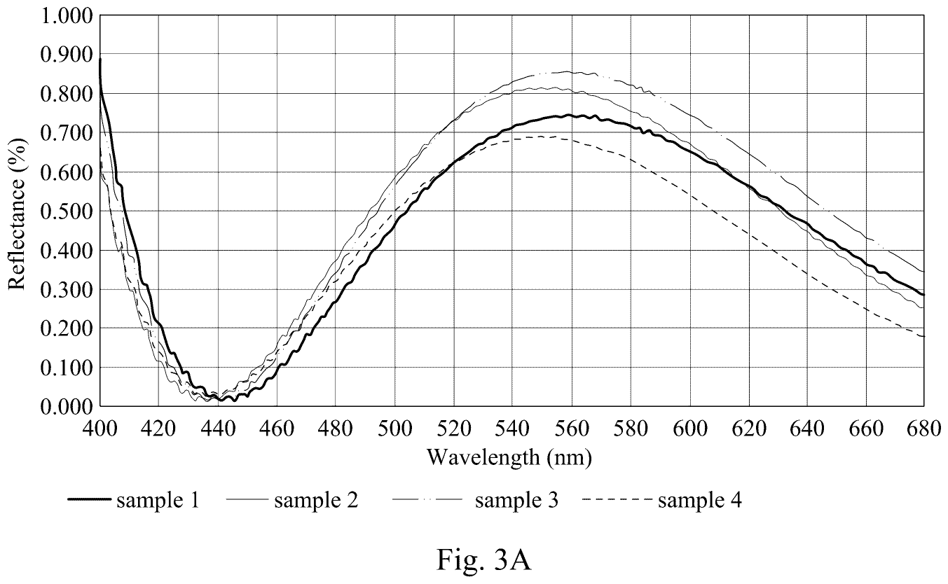

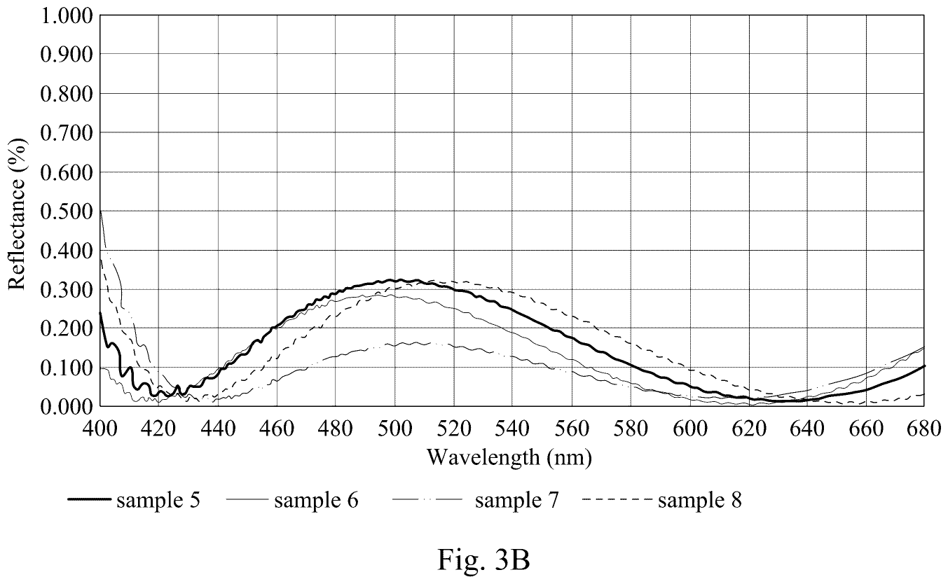

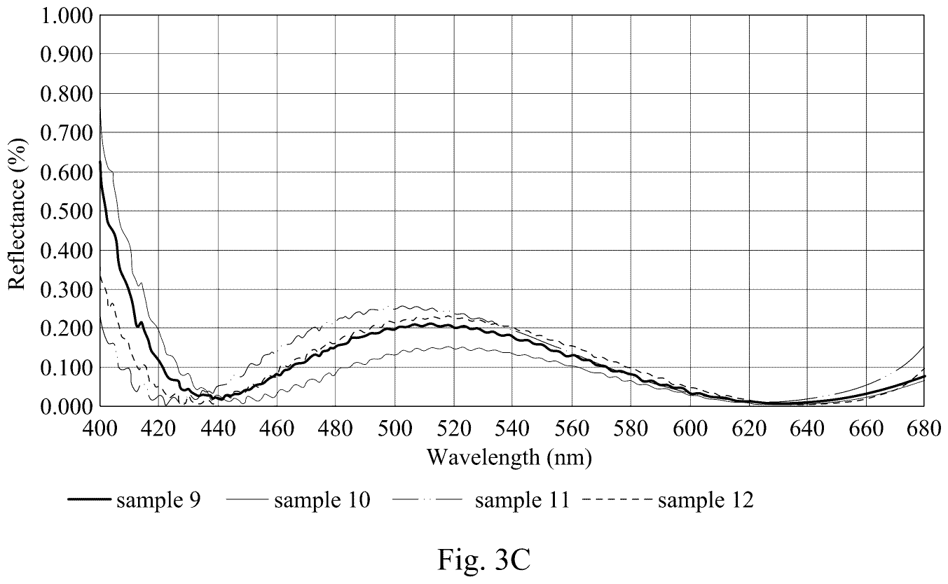

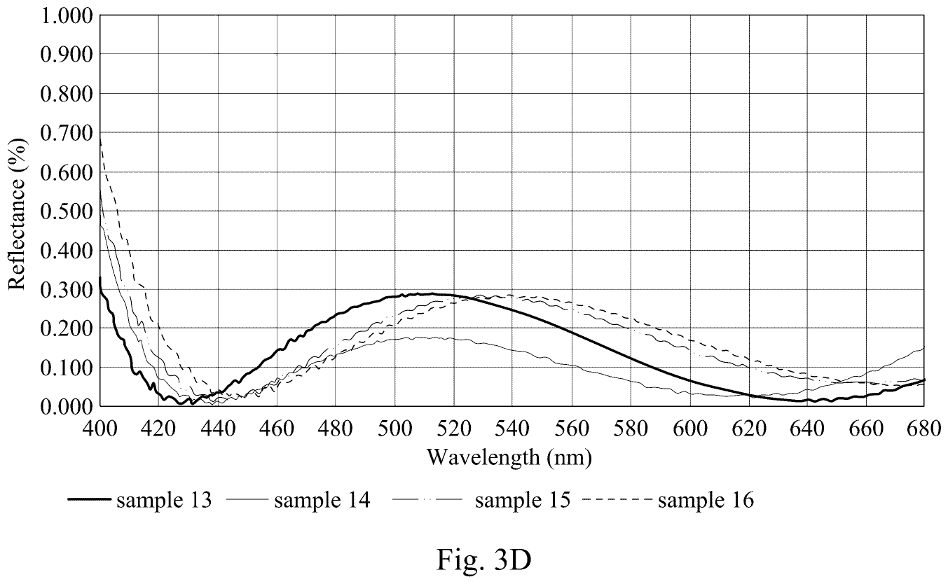

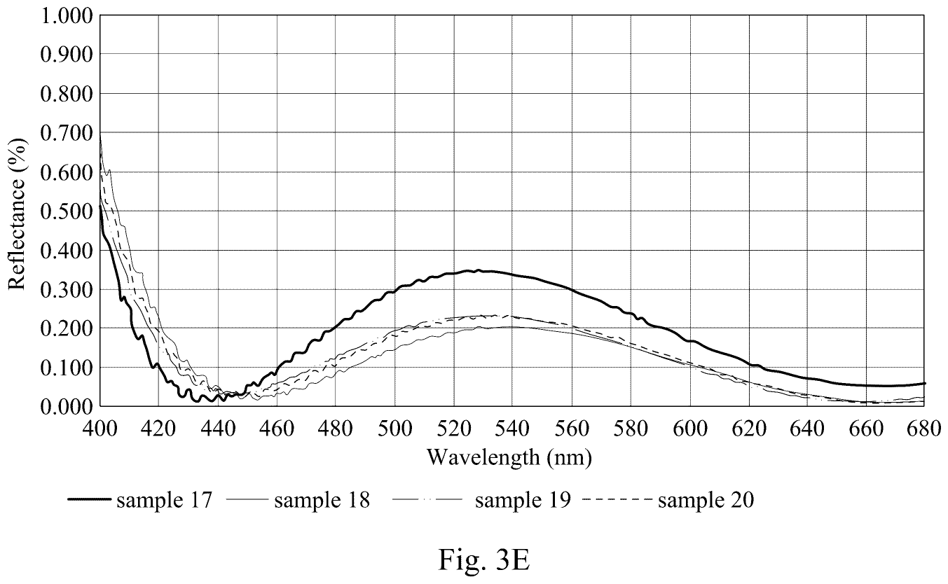

FIGS. 3A, 3B, 3C, 3D and 3E are schematic views of Reflectance (%)-Wavelength (nm) of the anti-reflection coatings which are coated on the tested lens elements according to the 1st example to 20th example (which are showed in sample 1 to sample 20) of the present disclosure. Specifically, FIG. 3A is a schematic view of Reflectance (%)-Wavelength (nm) of the anti-reflection coatings which are coated on the tested lens elements of the 1st example (sample 1), the 2nd example (sample 2), the 3rd example (sample 3) and the 4th example (sample 4), FIG. 3B is a schematic view of Reflectance (%)-Wavelength (nm) of the anti-reflection coatings which are coated on the tested lens elements of the 5th example (sample 5), the 6th example (sample 6), the 7th example (sample 7) and the 8th example (sample 8), FIG. 3C is a schematic view of Reflectance (%)-Wavelength (nm) of the anti-reflection coatings which are coated on the tested lens elements of the 9th example (sample 9), the 10th example (sample 10), the 11th example (sample 11) and the 12th example (sample 12), FIG. 3D is a schematic view of Reflectance (%)-Wavelength (nm) of the anti-reflection coatings which are coated on the tested lens elements of the 13th example (sample 13), the 14th example (sample 14), the 15th example (sample 15) and the 16th example (sample 16), and FIG. 3E is a schematic view of Reflectance (%)-Wavelength (nm) of the anti-reflection coatings which are coated on the tested lens elements of the 17th example (sample 17), the 18th example (sample 18), the 19th example (sample 19) and the 20th example (sample 20), wherein, in the present disclosure, samples 1-4 are classified to B-type anti-reflection coating, and samples 5-20 are classified to A-type anti-reflection coating.

In the following Table 1A-Table 1E, which show datum of samples 1-20 in FIG. 3A, FIG. 3B, FIG. 3C, FIG. 3D and FIG. 3E. In detail, the wavelength from 400 nm to 680 nm relative to the reflectance of the anti-reflection coating can be separated to three wavelength bands, which are, from short to long, a first wavelength band, a second wavelength band and a third wavelength band, wherein the first wavelength band is from 400 nm to 470 nm, a minimum reflectance relative to the first wavelength band is a first reference value, the first reference value is RV1; the second wavelength band is from 480 nm to 580 nm, a maximum reflectance relative to the second wavelength band is a second reference value, the second reference value is RV2; the third wavelength band is from 600 nm to 680 nm, a minimum reflectance relative to the third wavelength band is a third reference value, the third reference value is RV3; an average reflectance relative to the first wavelength band is RA1, an average reflectance relative to the second wavelength band is RA2, an average reflectance relative to the third wavelength band is RA3, an average reflectance of the anti-reflection coating relative to the wavelength from 400 nm to 680 nm is Ravg.

TABLE 1A

| | sample 1 | sample 2 | sample 3 | sample 4 |
|---|---|---|---|---|
| RV1 (%) | 0.015 | 0.015 | 0.016 | 0.025 |
| RV2 (%) | 0.745 | 0.815 | 0.856 | 0.689 |
| RV3 (%) | 0.286 | 0.252 | 0.343 | 0.178 |
| RV2/RV1 | 48.377 | 55.068 | 54.541 | 28.139 |
| Ravg (%) | 0.457 | 0.482 | 0.522 | 0.404 |
| RA1 (%) | 0.197 | 0.163 | 0.183 | 0.167 |
| RA2 (%) | 0.611 | 0.702 | 0.717 | 0.595 |
| RA3 (%) | 0.465 | 0.450 | 0.540 | 0.347 |

Table - 1B

| | sample 5 | sample 6 | sample 7 | sample 8 |
|---|---|---|---|---|
| RV1 (%) | 0.027 | 0.010 | 0.012 | 0.012 |
| RV2 (%) | 0.322 | 0.285 | 0.162 | 0.321 |
| RV3 (%) | 0.014 | 0.004 | 0.020 | 0.008 |
| RV2/RV1 | 11.933 | 28.788 | 13.829 | 26.279 |
| Ravg (%) | 0.144 | 0.121 | 0.093 | 0.147 |
| RA1 (%) | 0.117 | 0.102 | 0.103 | 0.104 |
| RA2 (%) | 0.249 | 0.201 | 0.123 | 0.269 |
| RA3 (%) | 0.038 | 0.044 | 0.058 | 0.032 |

Table - 1C

| | sample 9 | sample 10 | sample 11 | sample 12 |
|---|---|---|---|---|
| RV1 (%) | 0.017 | 0.008 | 0.002 | 0.006 |
| RV2 (%) | 0.210 | 0.153 | 0.257 | 0.230 |
| RV3 (%) | 0.009 | 0.004 | 0.009 | 0.003 |
| RV2/RV1 | 12.162 | 18.852 | 116.864 | 38.300 |
| Ravg (%) | 0.110 | 0.095 | 0.114 | 0.105 |
| RA1 (%) | 0.132 | 0.157 | 0.086 | 0.084 |
| RA2 (%) | 0.167 | 0.121 | 0.196 | 0.187 |
| RA3 (%) | 0.027 | 0.021 | 0.041 | 0.024 |

Table - 1D

| | sample 13 | sample 14 | sample 15 | sample16 |
|---|---|---|---|---|
| RV1 (%) | 0.007 | 0.006 | 0.012 | 0.021 |
| RV2 (%) | 0.287 | 0.175 | 0.282 | 0.281 |
| RV3 (%) | 0.012 | 0.024 | 0.058 | 0.052 |
| RV2/RV1 | 39.861 | 30.172 | 24.128 | 13.131 |
| Ravg (%) | 0.131 | 0.099 | 0.158 | 0.171 |
| RA1 (%) | 0.096 | 0.101 | 0.123 | 0.166 |
| RA2 (%) | 0.236 | 0.138 | 0.242 | 0.240 |
| RA3 (%) | 0.032 | 0.060 | 0.083 | 0.092 |

Table - 1E

| | sample 17 | sample 18 | sample 19 | sample 20 |
|---|---|---|---|---|
| RV1 (%) | 0.012 | 0.017 | 0.027 | 0.024 |
| RV2 (%) | 0.347 | 0.203 | 0.233 | 0.231 |
| RV3 (%) | 0.052 | 0.009 | 0.010 | 0.009 |
| RV2/RV1 | 30.165 | 11.678 | 8.647 | 9.564 |
| Ravg (%) | 0.182 | 0.126 | 0.129 | 0.132 |
| RA1 (%) | 0.118 | 0.167 | 0.139 | 0.151 |
| RA2 (%) | 0.300 | 0.170 | 0.198 | 0.196 |
| RA3 (%) | 0.086 | 0.040 | 0.037 | 0.040 |

The anti-reflection coating of the 1st example to the 20th example can be applied to any one of the anti-reflection coatings in the 1st Embodiment and the 2nd Embodiment, and the present disclosure will not be limited thereto.

### 3rd Embodiment

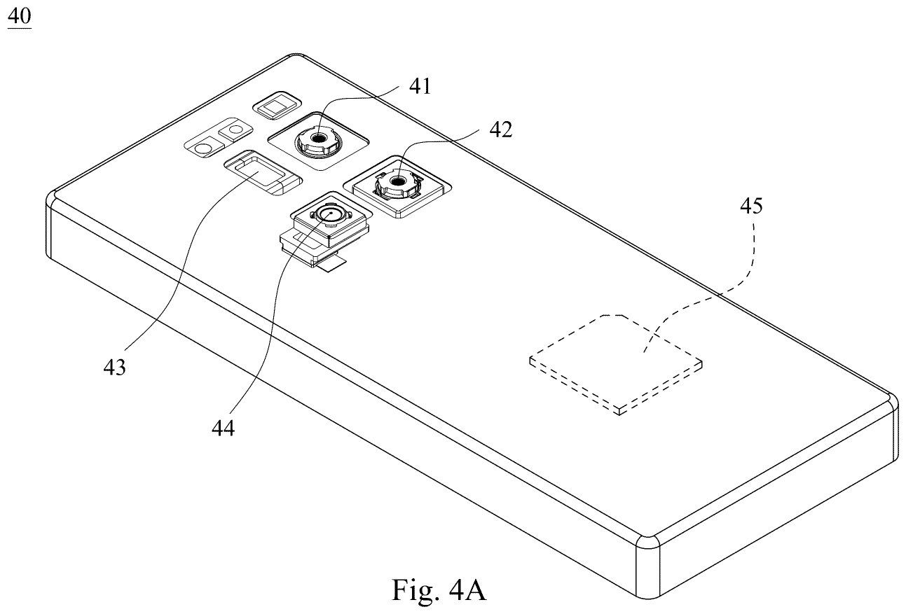

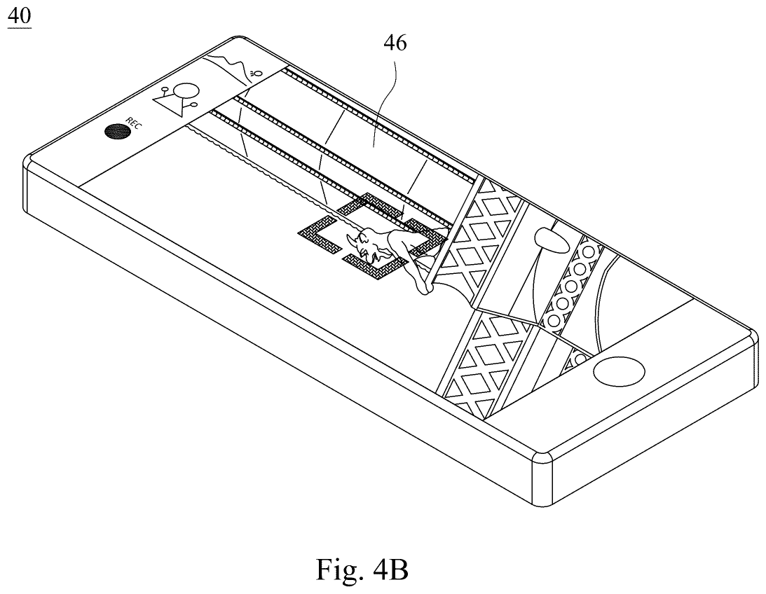

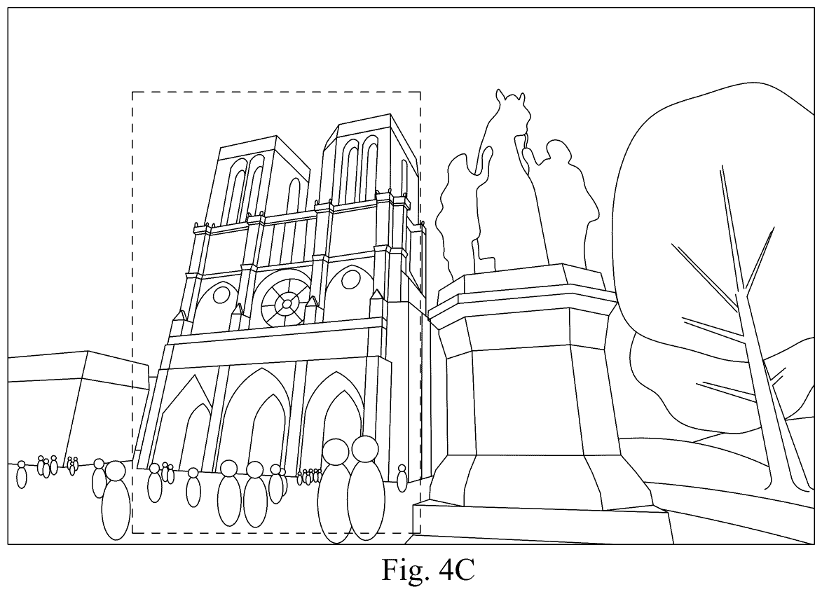

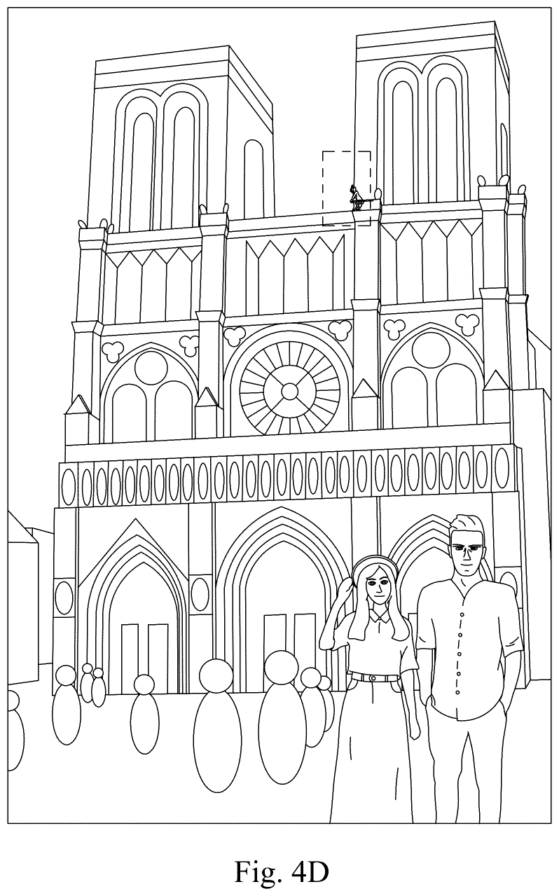

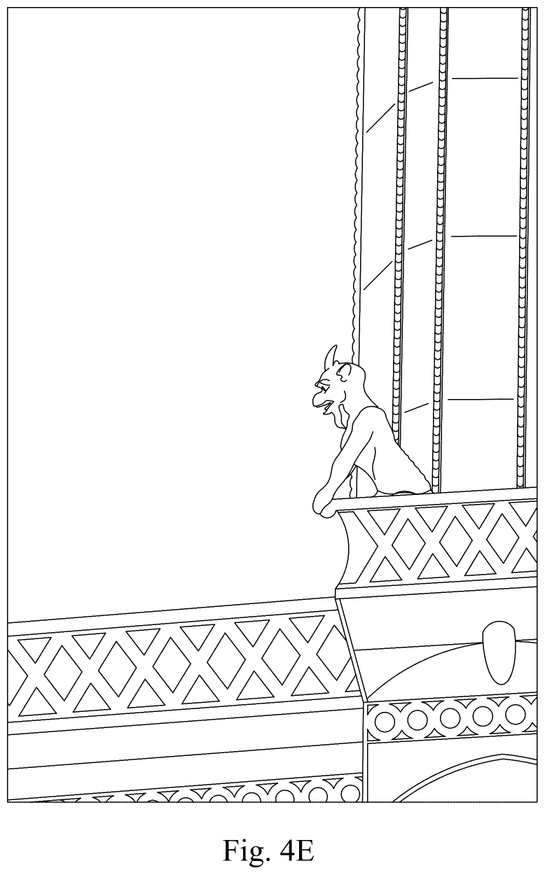

FIG. 4A is a schematic view of an electronic device 40 according to the 3rd Embodiment of the present disclosure. FIG. 4B is another schematic view of the electronic device 40 according to the 3rd Embodiment of FIG. 4A. As shown in FIG. 4A and FIG. 4B, the electronic device 40 is a smartphone. The electronic device 40 includes camera modules and a user interface 46, wherein each camera module can includes the imaging lens assembly according to any one of the aforementioned 1st to 2nd Embodiments. In detail, the camera modules are a high-pixel camera module 41, an ultra-wide-angle camera module 42, and two telephoto camera modules 43, 44, and the user interface 46 is a touch screen, but the present disclosure is not limited thereto.

A user enters a shooting mode via the user interface 46. The user interface 46 is used to display the screen, and the shooting angle can be manually adjusted to switch between different camera modules. At this moment, the camera modules collect an imaging light on the respective image sensor (not shown in figures) and output electronic signals associated with images to an image signal processor (ISP) 45.

As shown in FIG. 4A, according to the camera specifications of the electronic device 40, the electronic device 40 can further include an optical anti-shake mechanism (not shown in figures). Further, the electronic device 40 can further include at least one focusing assisting module (not shown in figures) and at least one sensing component (not shown in figures). The focusing assisting module can be a flash module, an infrared distance measurement component, a laser focus module, etc. The flash module is for compensating the color temperature. The sensing component can have functions for sensing physical momentum and kinetic energies, such as an accelerator, a gyroscope, and a Hall effect element, so as to sense shaking or jitters applied by hands of the user or external environments. Thus the autofocus function and the optical anti-shake mechanism of the imaging lens assembly disposed on the electronic device 40 can function to obtain a great image quality and facilitate the electronic device 40 according to the present disclosure to have a capturing function with multiple modes, such as taking optimized selfies, high dynamic range (HDR) with a low light source, 4K resolution recording, etc. Furthermore, the user can visually see the captured image of the camera through the user interface 46 and manually operate the view finding range on the user interface 46 to achieve the auto focus function of what you see is what you get.

Furthermore, the camera modules, the optical anti-shake mechanism, the sensing component and the focusing assisting module can be disposed on a flexible printed circuit board (FPC) (not shown in figures) and electrically connected to the image signal processor 45 and so on via a connector (not shown in figures) so as to operate a picturing process. Recent electronic devices such as smartphones have a trend towards thinness and lightness. The camera modules and the related elements are disposed on a FPC and circuits are assembled into a main board of an electronic device by a connector. Hence, it can fulfill a mechanical design of a limited inner space of the electronic device and a requirement of a circuit layout and obtain a larger allowance, and it is also favorable for autofocus functions of the camera modules obtaining a flexible control via a touch screen of the electronic device. In the 3rd embodiment, the electronic device 40 can include a plurality of the sensing components and a plurality of the focusing assisting modules, and the sensing components and the focusing assisting modules are disposed on an FPC and another at least one FPC (not shown in figures) and electrically connected to the image signal processor 45 and so on via a corresponding connector so as to operate a picturing process. In other embodiments (not shown in figures), the sensing components and auxiliary optical elements can be disposed on a main board of an electronic device or a board of the other form according to a mechanical design and a requirement of a circuit layout.

Furthermore, the electronic device 40 can further include, but not be limited to, a display, a control unit, a storage unit, a random-access memory (RAM), a read-only memory (ROM), or the combination thereof.

FIG. 4C is a schematic view of an image captured via the electronic device 40 according to the 3rd embodiment of FIG. 4A. As shown in FIG. 4C, a larger ranged image can be captured via the ultra-wide-angle camera module 42, which has a function for containing more views.

FIG. 4D is another schematic view of the image captured via the electronic device 40 according to the 3rd embodiment of FIG. 4A. As shown in FIG. 4D, a certain ranged and high-pixel image can be captured via the high-pixel camera module 41, which has a function for high resolution and low distortion.

FIG. 4E is the other schematic view of the image captured via the electronic device 40 according to the 3rd embodiment of FIG. 4A. As shown in FIG. 4E, a far image can be captured and enlarged to a high magnification via the telephoto camera modules 43, 44, which has a function for a high magnification.

As shown in FIG. 4C to FIG. 4E, when an image is captured via different camera modules having various focal lengths and processed via a technology of an image processing, a zoom function of the electronic device 40 can be achieved.

### 4th Embodiment

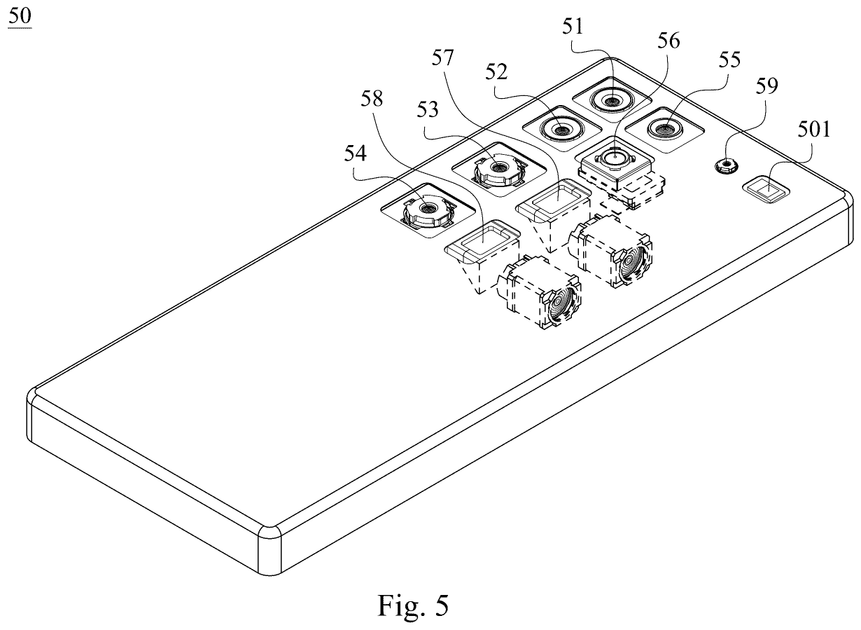

FIG. 5 is a schematic view of an electronic device 50 according to the 4th embodiment of the present disclosure. As shown in FIG. 5, the electronic device 50 is a smartphone. The electronic device 50 includes a plurality of camera modules, wherein each camera module can includes the imaging lens assembly according to any one of the aforementioned 1st to 2nd embodiments, but the present disclosure is not limited thereto. In detail, camera modules are two ultra-wide-angle camera modules 51, 52, two wide angle camera modules 53, 54, four telephoto camera modules 55, 56, 57, 58, and a Time-Of-Flight (TOF) module 59, the TOF module 59 can be other types of camera module, which will not be limited to the present arrangement.

Further, the camera modules 57, 58 can have folding function of the light path, but the present disclosure will not be limited thereto.

According to the camera specifications of the electronic device 50, the electronic device 50 can further include an optical anti-shake mechanism (not shown in figures). Further, the electronic device 50 can further include at least one focusing assisting module (not shown in figures) and at least one sensing component (not shown in figures). The focusing assisting module can be a flash module 501, an infrared distance measurement component, a laser focus module, etc. The flash module 501 is for compensating the color temperature. The sensing component can have functions for sensing physical momentum and kinetic energies, such as an accelerator, a gyroscope, and a Hall effect element, so as to sense shaking or jitters applied by hands of the user or external environments. Thus, the autofocus function and the optical anti-shake mechanism of the camera modules disposed on the electronic device 50 can function to obtain a great image quality and facilitate the electronic device 50 according to the present disclosure to have a capturing function with multiple modes, such as taking optimized selfies, high dynamic range (HDR) with a low light source, 4K resolution recording, etc.

Furthermore, all of other structures and dispositions according to the 4th embodiment are the same as the structures and the dispositions according to the 3rd embodiment, and will not be described again herein.

The foregoing description, for purpose of explanation, has been described with reference to specific examples. It is to be noted that Tables show different data of the different examples; however, the data of the different examples are obtained from experiments. The examples were chosen and described in order to best explain the principles of the disclosure and its practical applications, to thereby enable others skilled in the art to best utilize the disclosure and various examples with various modifications as are suited to the particular use contemplated. The examples depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens assembly, having an optical axis, comprising:
a lens element assembly comprising a plurality of lens elements, the lens elements disposed along the optical axis, and comprising:
a first lens element comprising:
a first object-side surface, the optical axis passing through the first object-side surface; and
a first image-side surface disposed relative to the first object-side surface along the optical axis;
a second lens element comprising:
a second object-side surface, the optical axis passing through the second object-side surface; and
a second image-side surface disposed relative to the second object-side surface along the optical axis;
at least two anti-reflection coatings disposed on at least one surface of the first object-side surface and the first image-side surface and at least one surface of the second object-side surface and the second image-side surface, each of the at least two anti-reflection coatings comprising:
a nano structure layer, a main material of the nano structure layer being Aluminium Oxide, wherein the nano structure layer comprises a plurality of ridge-like protrusions extending non-directionally, each of the ridge-like protrusions tapers and extends from a bottom to a top, and a structure average height of the ridge-like protrusions is greater than 26 nm and smaller than 356 nm; and
an intermediate layer disposed between the nano structure layer and the at least one surface;
wherein, a wavelength from 400 nm to 680 nm relative to a reflectance of each of the at least two anti-reflection coatings can be separated to two wavelength bands, which are, from short to long, a first wavelength band and a second wavelength band, wherein the first wavelength band is from 400 nm to 470 nm, a minimum reflectance relative to the first wavelength band is a first reference value, the first reference value is RV1, the second wavelength band is from 480 nm to 580 nm, a maximum reflectance relative to the second wavelength band is a second reference value, the second reference value is RV2, and the following conditions are satisfied:
$$\begin{matrix}0 \% < RV 1 < 0.1 \% ; and \\ 0.1 \% < RV 2 < 1 \% .\end{matrix}$$

2. The imaging lens assembly of claim 1, wherein an average reflectance relative to the second wavelength band is RA2, and the following condition is satisfied:
$$0.5 \% < RA 2 < 0.9 \% .$$

3. The imaging lens assembly of claim 2, wherein the second reference value is RV2, and the following condition is satisfied:
$$0.5 \% VRV 2 < 1 \% .$$

4. The imaging lens assembly of claim 1, wherein an average reflectance relative to the second wavelength band is RA2, and the following condition is satisfied:
$$0.1 \% < RA 2 < 0.35 \% .$$

5. The imaging lens assembly of claim 4, wherein the second reference value is RV2, and the following condition is satisfied:
$$0.15 \% < RV 2 < 0.5 \% .$$

6. The imaging lens assembly of claim 5, wherein the wavelength from 400 nm to 680 nm relative to the reflectance of each of the at least two anti-reflection coatings can be further separated to a third wavelength band, the third wavelength band is from 600 nm to 680 nm, a minimum reflectance relative to the third wavelength band is a third reference value, the third reference value is RV3, and the following condition is satisfied:
$$0 \% < RV 3 < 0.1 \% .$$

7. The imaging lens assembly of claim 6, wherein an average reflectance relative to the first wavelength band is RA1, and the following condition is satisfied:
$$0 \% < RA 1 < 0.2 \% .$$

8. The imaging lens assembly of claim 6, wherein an average reflectance relative to the third wavelength band is RA3, and the following condition is satisfied:
$$0 \% < RA 3 < 0.1 \% .$$

9. The imaging lens assembly of claim 1, wherein a paraxial distance between the first object-side surface and the first image-side surface is D, and the following condition is satisfied:
$$0.1 mm < D \leq 0.42 mm .$$

10. The imaging lens assembly of claim 1, further comprising:
a third lens element comprising:
a third object-side surface, the optical axis passing through the third object-side surface; and
a third image-side surface disposed relative to the third object-side surface along the optical axis;
wherein, a number of the at least two anti-reflection coatings is at least three, one of the at least three anti-reflection coatings is disposed on at least one surface of the third object-side surface and the third image-side surface of the third lens element;
wherein, the wavelength from 400 nm to 680 nm relative to a reflectance of the anti-reflection coating disposed on the third lens element can be further separated to a third wavelength band, the third wavelength band is from 600 nm to 680 nm, a minimum reflectance relative to the third wavelength band is a third reference value, the third reference value is RV3, and the following condition is satisfied:
$$0 \% < RV 3 < 0.1 \% .$$

11. The imaging lens assembly of claim 1, wherein an average reflectance of each of the at least two anti-reflection coatings relative to the wavelength from 400 nm to 680 nm is Ravg, and the following condition is satisfied:
$$0 \% < Ravg < 0.6 \% .$$

12. The imaging lens assembly of claim 1, wherein the first reference value is RV1, the second reference value is RV2, and the following condition is satisfied:
$$5 < RV 2 / RV 1 < 70.$$

13. The imaging lens assembly of claim 1, wherein a number of the lens elements of the lens element assembly is at least seven.

14. The imaging lens assembly of claim 1, wherein a top of the intermediate layer is partially contacted with air.

15. The imaging lens assembly of claim 1, wherein the structure average height of the ridge-like protrusions is greater than 41 nm and smaller than 236 nm.

16. The imaging lens assembly of claim 1, wherein in the lens element assembly, a number of the lens elements with at least two anti-reflection coatings accounts for at least 40% of a total number of the lens elements.

17. An imaging lens assembly, having an optical axis, comprising:
a lens element assembly comprising a plurality of lens elements, the lens elements disposed along the optical axis, and comprising:
a first lens element comprising:
a first object-side surface, the optical axis passing through the first object-side surface; and
a first image-side surface disposed relative to the first object-side surface along the optical axis; and
at least one anti-reflection coating disposed on at least one surface of the first object-side surface and the first image-side surface, the at least one anti-reflection coating comprising:
a nano structure layer, a main material of the nano structure layer being Aluminium Oxide, wherein the nano structure layer comprises a plurality of ridge-like protrusions extending non-directionally, each of the ridge-like protrusions tapers and extends from a bottom to a top, and a structure average height of the ridge-like protrusions is greater than 26 nm and smaller than 356 nm; and
an intermediate layer disposed between the nano structure layer and the at least one surface;
wherein, a paraxial distance between the first object-side surface and the first image-side surface is D, and the following condition is satisfied:
$$0.1 mm < D \leq 0.42 mm ;$$
wherein, a wavelength from 400 nm to 680 nm relative to a reflectance of the at least one anti-reflection coating can be separated to two wavelength bands, which are, from short to long, a first wavelength band and a second wavelength band, wherein the first wavelength band is from 400 nm to 470 nm, a minimum reflectance relative to the first wavelength band is a first reference value, the first reference value is RV1, the second wavelength band is from 480 nm to 580 nm, a maximum reflectance relative to the second wavelength band is a second reference value, the second reference value is RV2, and the following conditions are satisfied:
$$0 \% < RV 1 < 0.1 \% ; and$$
$$0.5 \% < RV 2 < 1 \% .$$

18. The imaging lens assembly of claim 17, wherein the paraxial distance between the first object-side surface and the first image-side surface is D, and the following condition is satisfied:
$$0.15 mm < D \leq 0.3 \; 75 mm .$$

19. The imaging lens assembly of claim 17, wherein an average reflectance relative to the second wavelength band is RA2, and the following condition is satisfied:
$$0.5 \% < RA 2 < 0.9 \% .$$

20. The imaging lens assembly of claim 19, wherein an average reflectance relative to the first wavelength band is RA1, and the following condition is satisfied:
$$0 \% < RA 1 < 0.2 \% .$$

21. The imaging lens assembly of claim 17, wherein an average reflectance of each of the at least one anti-reflection coating relative to the wavelength from 400 nm to 680 nm is Ravg, and the following condition is satisfied:
$$0 \% < Ravg < 0.6 \% .$$

22. The imaging lens assembly of claim 17, wherein the first reference value is RV1, the second reference value is RV2, and the following condition is satisfied:
$$5 < RV 2 / RV 1 < 70 .$$

23. The imaging lens assembly of claim 17, wherein a number of the lens elements of the lens element assembly is at least seven.

24. The imaging lens assembly of claim 17, wherein a top of the intermediate layer is partially contacted with air.

25. The imaging lens assembly of claim 17, wherein the structure average height of the ridge-like protrusions is greater than 41 nm and smaller than 236 nm.

26. An electronic device, comprising:
the imaging lens assembly of claim 1.

27. An electronic device, comprising:
the imaging lens assembly of claim 17.
